(19) United States
(12) Patent Application Publication
(10) Pub. No.: US 2009/0185121 A9
(43) Pub. Date: Jul. 23, 2009

(54) Display base having a retardation control function with a high voltage holding ratio

(75) Inventors: Atsushi Suemasu, Tokyo (JP); Norihisa Moriya, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: DAI NIPPON PRINTING CO., LTD., Tokyo (JP)

(21) Appl. No.: 11/393,648

(22) Filed: Mar. 31, 2006

Related U.S. Application Data
(63) Continuation-in-part of application No. 10/864,307, filed on Jun. 8, 2004, now Pat. No. 7,286,199.

(30) Foreign Application Priority Data
Mar. 31, 2005 (JP) 105514/2005
Jun. 10, 2003 (JP) 2003-164527

(51) Int. Cl. G02F 1/1335

(52) U.S. Cl. 349/117

(57) ABSTRACT

A display board with a retardation control function has a retardation control layer containing liquid crystalline polymers with a fixed orientation, and a liquid crystal layer. The display board has a voltage holding ratio of 90% or higher after a forced impurity extraction is performed on the display board with the retardation control layer in contact with the liquid crystal layer, and application of a voltage to the liquid crystal layer. The display board is capable of providing a high quality display while preventing a drop in the voltage holding ratio attributed to impurities mixed into the liquid crystal layer, and thus preventing the occurrence of display defects, such as flickering.

### BACKGROUND OF THE INVENTION AND RELATED ART STATEMENT

The present invention relates to a display base with a retardation control function and a liquid crystal display using the display base, and particularly relates to a liquid crystal display with excellent display quality and the display base used for the liquid crystal display.

In recent years, various liquid crystal displays have been in practical use, and particularly for the purpose of expanding a visionary angle, a display using a retardation film has been widely used. For example, a translucent color liquid crystal display is one of such known displays, wherein a polarizing plate, a retardation film, a substrate, a coloring layer, a counter electrode (transparent conductive film), an alignment film, a liquid crystal layer, an alignment film, a pixel electrode (transparent conductive film), a glass substrate, a retardation film, and a polarizing plate are laminated in this order to compose a liquid crystal device to which a back light is lit from the side opposite from the observing side so as to display images, etc. The retardation film is generally provided attached to a polarizing plate using an adhesive. In addition, other than a translucent display, a reflective liquid crystal display capable of displaying images, etc. using a reflector plate without a back light, or a transreflective liquid crystal display, are known.

In any type of liquid crystal display, a high quality display without flickering is required.

As for the cause of flickering on a display, the major cause is considered to be impurities, such as ionic substances generated within a liquid crystal display, entering into a liquid crystal layer and traveling into the liquid crystal layer, preventing the voltage applied on the liquid crystal layer from being held for a certain period of time. As for the source of impurities, such as the ionic substances, several varieties of such may be cited. For example, given are: impurities contained in the chemicals used in manufacturing processes; impurities in the atmosphere and pure water etc.; dust generated from devices, human bodies etc.; residues from ultra violet radiation/surface polishing, etc. during manufacturing processes; ionic substances extracted from resin members contained in the coloring layer; and ionic substances extracted from the adhesive used to attach a retardation film onto a polarizing plate, and the like.

Various attempts have been made to remove impurities by cleaning the surface of each composite layer or by optimizing the processing conditions, and the like, as counter measures to prevent impurities from being mixed into a liquid crystal layer. However, under severe display conditions, particularly in high temperatures or high humidity etc., there is still a tendency for display defects to occur.

The present applicants have already proposed a color filter with a high voltage holding ratio in order to solve the occurrence of display defects (see Japanese Unexamined Patent Application Publication No. 2002-311228). A display using such a color filter is capable of providing a liquid crystal display having high display quality without flickering, etc.

However, instead of being restricted to using a particular color filter, a request has been made to use various suitably selected color filters in the manufacture of various types of liquid crystal displays.

The present invention has been created in view of the above described situation. An object of the invention is to provide a liquid crystal display that is capable of preventing impurities, such as ionic substances etc. from being mixed into the liquid crystal layer without restricting the selection of color filters, while still providing excellent display quality, even for display over many hours, etc. in high temperatures and high humidity, and to provide a display base with a high voltage holding ratio to be used for the liquid crystal display.

Further objects and advantages of the invention will be apparent from the following description of the invention and the associated drawings.

### SUMMARY OF THE INVENTION

According to one embodiment, the present invention includes:

(1) A display base having a retardation control function comprising a substrate and a retardation control layer composed of liquid crystalline polymer in a fixed alignment, wherein forced impurity extraction is conducted on the display base with the retardation control layer in contact with the liquid crystal layer, and next, when a voltage is applied, the holding ratio of the voltage applied on the liquid crystals is greater than 90%.

(2) A display base having a retardation control function according to aspect (1), wherein a coloring layer is provided between the substrate and the retardation control layer.

(3) A liquid crystal display, wherein a display base is used having a retardation control function according to aspects (1) or (2), and,

(4) A liquid crystal display according to aspect (3), wherein a counter electrode, an alignment film, a liquid crystal layer, an alignment film, and a pixel electrode are provided in this order, and the retardation control layer is adjacently provided on the side opposite from the alignment film of the counter electrode.

The display base having a retardation control function according to the present invention is capable of holding a voltage applied to the liquid crystal at a value greater than 90%, even when the voltage is applied after the forced impurity extraction on the display base with the retardation control layer in contact with the liquid crystal layer. Moreover, the high voltage holding ratio for the liquid crystals is achievable without being restricted to a particular color filter.

Therefore, for the liquid crystal display, a display base having a retardation control function according to the present invention is used that is capable of providing high display quality while preventing a drop in the voltage holding ratio attributed to impurities mixed into the liquid crystal layer, even for display over many hours under severe display conditions, such as high temperature and high humidity, and thus preventing the occurrence of display defects, such as flickering. Furthermore, the color liquid crystal display is not restricted to a particular color filter, so that a desired color filter may be adopted by appropriate selection.

### BRIEF DESCRIPTION OF THE DRAWINGS

FIG. 1 is an exploded perspective view showing one embodiment of the display board according to the present invention.

FIG. 2 is an exploded perspective view showing another embodiment of the display board according to the present invention.

FIG. 3 is an exploded perspective view showing another embodiment of the display board according to the present invention.

FIG. 4 is an exploded perspective view showing another embodiment of the display board according to the present invention.

FIG. 5 is an exploded perspective view showing another embodiment of the display board according to the present invention.

FIG. 6 illustrates the structure of a liquid crystal cell for measurement of a process of forced impurity extraction and measurement of a voltage holding ratio.

FIG. 7 illustrates the structure of another liquid crystal cell for measurement of the process of forced impurity extraction and measurement of the voltage holding ratio.

FIG. 8 is a cross-sectional view of one embodiment of an LCD according to the present invention.

FIG. 9 is a cross-sectional view of another embodiment of the LCD according to the present invention.

### DETAILED DESCRIPTION OF THE PREFERRED EMBODIMENTS

Preferred embodiments of the present invention are described below with reference to the drawings.

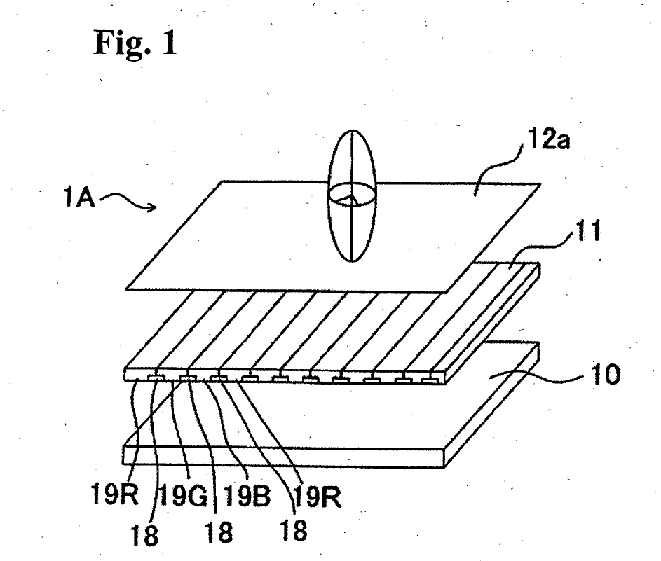

FIGS. 1-5 are exploded perspective views illustrating one embodiment of a display base having a retardation control function according to the present invention, where each layer composing the display base is arbitrarily separated as shown.

The display base 1A according to the present invention, shown in FIG. 1, is formed by laminating a coloring layer 11 composed of black matrixes 18 and red coloring matters 19R in order to form red patterns, green coloring matters 19G to form green patterns, and blue coloring matters 19B to form blue patterns on the top side of a substrate 10, and next, by laminating a retardation control layer 12a on the coloring layer 11. The retardation control layer 12a is a layer composed of liquid crystalline polymer in a fixed alignment, more specifically, a retardation control layer (hereinafter referred to as a “positive C plate”) that is composed by aligning and polymerizing a three dimensional crosslinkable, polymerizable liquid crystalline monomer so that the optical axis of the liquid crystalline polymer is vertical to the substrate and has a positive birefringence anisotropy.

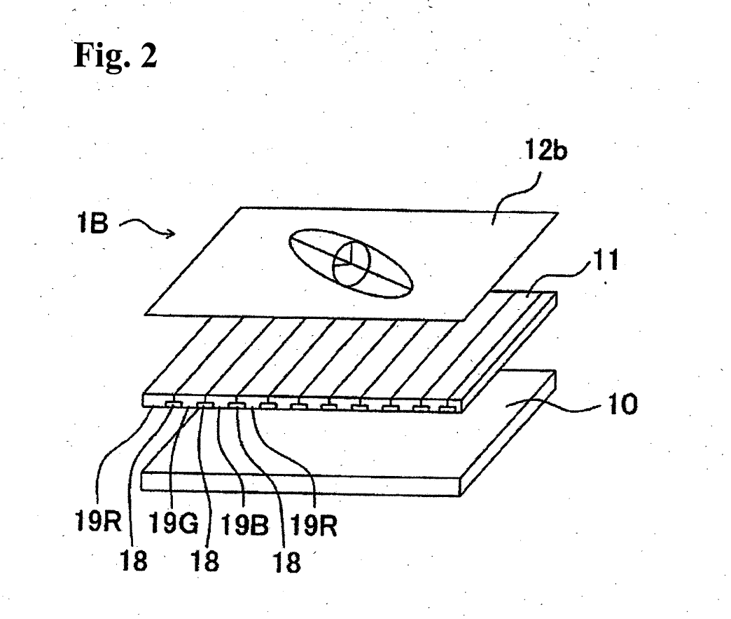

The display base 1B according to the present invention, shown in FIG. 2, is formed by laminating a coloring layer 11 on the top side of a substrate 10 such as the display base 1A, and next, by laminating a retardation control layer 12b on the top side of the coloring layer 11. The retardation control layer 12b is a layer composed of liquid crystalline polymer in a fixed alignment, more specifically, a retardation control layer (hereinafter referred to as a “positive A plate”) that is composed by aligning and polymerizing a three-dimensional crosslinkable, polymerizable liquid crystalline monomer so that the optical axis of the liquid crystalline polymer is horizontal to the substrate and has a positive birefringence anisotropy.

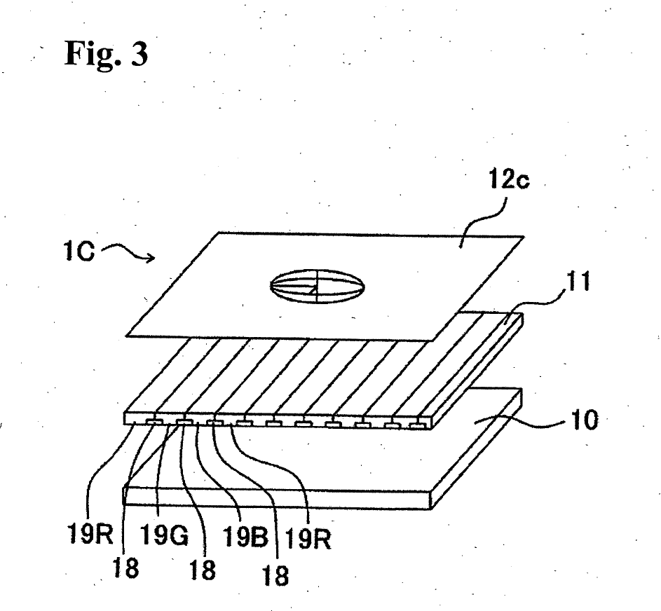

The display base 1C according to the present invention, shown in FIG. 3, is formed by laminating a coloring layer 11 on the top side of a substrate 10, such as the display base 1A, and next, by laminating a retardation control layer 12c on the top side of the coloring layer 11. The retardation control layer 12c is a layer composed of liquid crystalline polymer in a fixed alignment, more specifically, a retardation control layer (from hereon called as a “negative C plate”) that is composed by aligning and polymerizing a three dimensional crosslinkable polymerizable liquid crystalline monomer so that the optical axis of the liquid crystalline polymer is horizontal to the substrate and has a negative birefringence anisotropy.

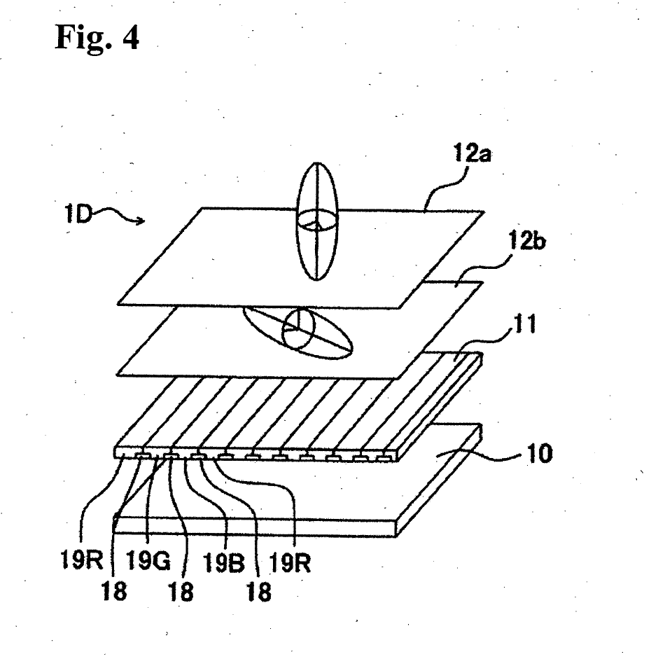

The display base 1D according to the present invention, shown in FIG. 4, is formed by laminating a coloring layer 11 on the top side of a substrate 10, and next, by laminating a retardation control layer 12b as a first retardation control layer on the top side of the coloring layer 11, where a retardation control layer 12a is further laminated as a second retardation control layer.

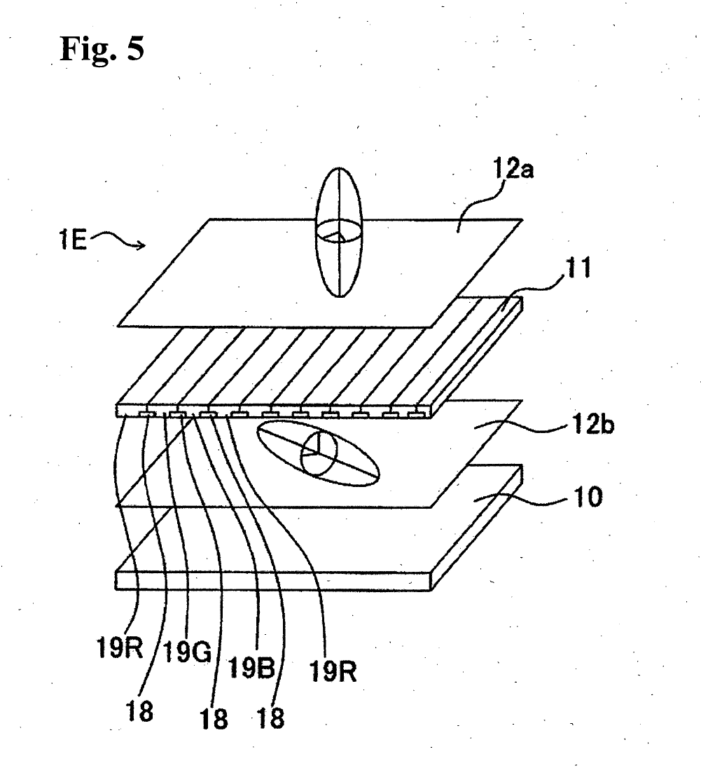

The display base 1E according to the present invention, shown in FIG. 5, is formed by laminating a retardation control layer 12b on the top side of a substrate 10, subsequently forming a coloring layer 11 on the top side of the retardation control layer 12b, and by further laminating a retardation control layer 12a on the top side of the coloring layer 11.

Furthermore, although not illustrated, with regard to the display base 1D and 1E illustrated in FIG. 4 and FIG. 5, the formation may be made by switching or replacing each of the retardation control layers 12a, 12b, and 12c, respectively.

A method for forming a retardation control layer used in the present invention is explained in detail below. The retardation control layer in the present invention includes a liquid crystalline polymer in a fixed alignment. A crosslinkable, polymerizable liquid crystalline monomer is used as the material composing the liquid crystalline polymer. The crosslinkable, polymerizable liquid crystalline monomer is capable of fixing liquid crystals at room temperature, and more concretely, has an unsaturated double bond molecule structure, therefore capable of fixing the liquid crystal structure by cross linking in a state of liquid crystal. As one example of such crosslinkable, liquid crystalline monomer material, for example, compounds (I) given as examples in the following Chemical Formula 1 through Chemical Formula 10 and compounds (II) contained in the general chemical formula shown in Chemical Formula 11 may be cited. The liquid crystalline monomer material that may be used in the present invention includes one type of compound, or a mixture of more than two types from among compounds (I) shown as examples in Chemical Formula 1 through Chemical Formula 10, one type of compound, or a mixture of more than two types from among compounds (II) shown in Chemical Formula 11, or any variation of these combinations may be used. Furthermore, in the case of the liquid crystalline monomer contained in the general chemical formula Chemical Formula 11, the x indicating a long chain of an alkyl family located on both ends of the aromatic ring is preferably 4 to 6 (integers).

Herein, the amount of retardation achieved by the retardation control layer and the alignment characteristics can be determined according to the birefringence Δ n of liquid crystalline polymer and the film thickness; therefore, Δ n is preferably approximately 0.03 to 0.20, and more preferably approximately 0.05 to 0.15. When Δ n is less than 0.03, the film thickness in the retardation control layer must be increased in order to obtain sufficient retardation, however, if the film is too thick, the liquid crystalline polymer surrounding the air side interface may not be capable of maintaining the required alignment. Moreover, the film thickness in the retardation control layer is preferably 0.1 μm to 5 μm. If the film thickness is less than 0.1 μm, sufficient retardation control may not be demonstrated.

The measurement of the birefringence may be conducted by measuring the retardation and the film thickness. To measure retardation, a commercially available device such as the KOBRA-21 series (Oji Scientific Instruments), etc., may be used. The wave length at the time of measurement is preferably a visible light region of 380 nm to 780 nm, and conducting the measurement near a larger luminosity of 550 nm is more preferable. In addition, to measure the film thickness, a commercially available device, such as the DEKTAK (Sloan's) stylus step measuring device, etc., may be used.

Furthermore, a liquid crystal layer may be used in which a patterning process has been performed by various printing methods or by a photolithography method.

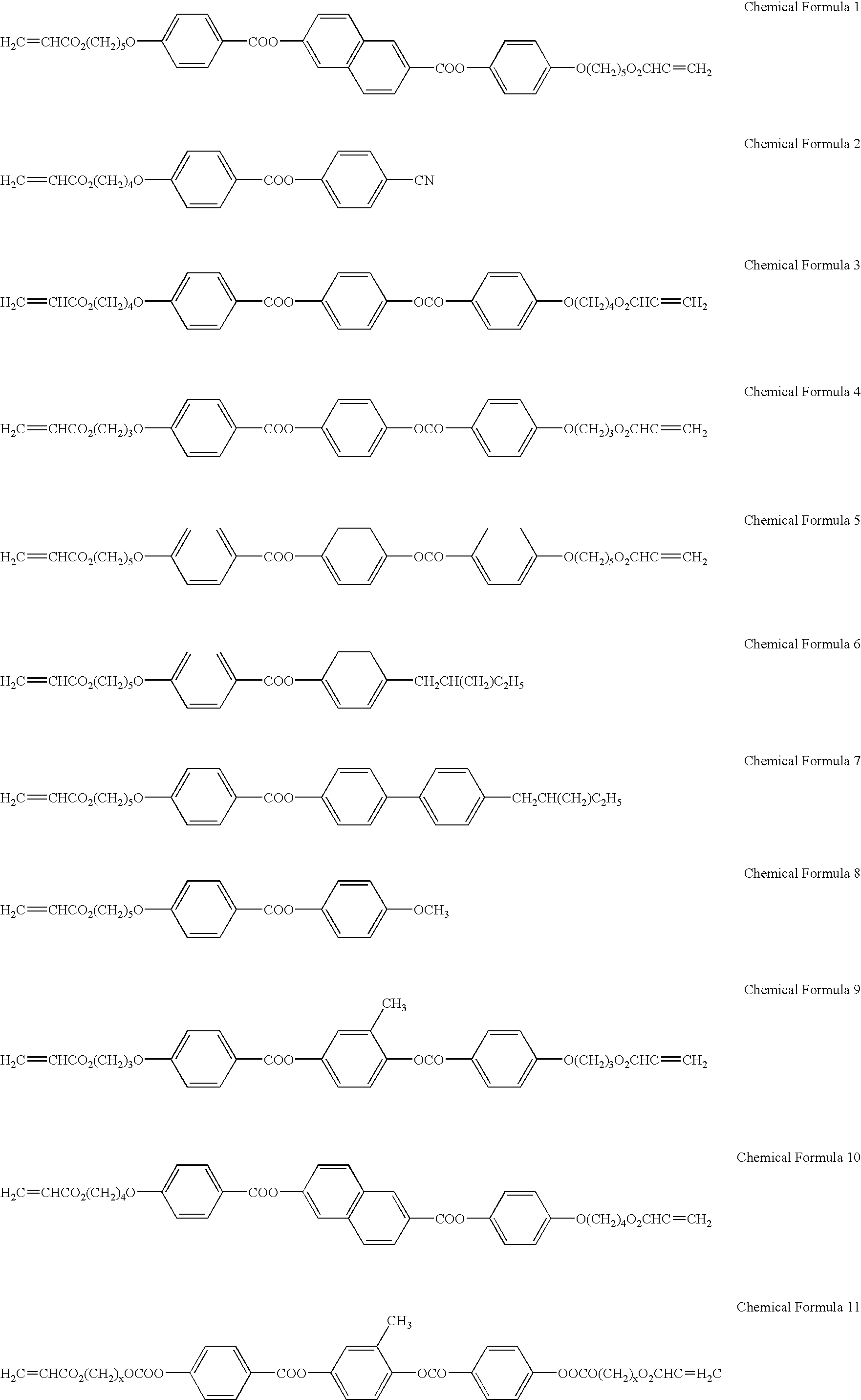

In order to create a positive C plate for the retardation control layer in the present invention, a coloring layer 11 must have the crosslinkable, liquid crystalline monomer nematically aligned in a direction vertical to the substrate. In order to be concrete, first, a vertical alignment film is formed on the coloring layer 11, and a resin composition containing a crosslinkable, liquid crystalline monomer is applied on the top side of the vertical alignment film, then heated to promote vertical alignment, and next, polymerization is conducted in a vertically aligned state by an irradiation of active radiation, such as ultraviolet radiation, etc. As a result, the liquid crystalline monomer is cross linked in an aligned state, in a direction vertical to the substrate, and the retardation control layer is formed composed of a fixed alignment of the liquid crystalline polymer.

For the vertical alignment film, a vertical alignment film formed by a surfactant having a long alkyl chain, a vertical alignment film formed by polyimids having a long alkyl chain, or a vertical alignment film formed by a coupling agent may be used. Also, commercially available vertical alignment films generally used for the driving liquid crystal layer of a vertically aligned liquid crystal display (MVA: Multi-domain Vertical Alignment method) may be used as well. As for the vertical alignment film available in the market, for example, JALS-2021-R2 (manufactured by JSR Corporation), SE-1211 (manufactured by Nissan Chemical Industries Ltd.), or SE-7511 (Nissan Chemical Industries Ltd.) etc. may be cited. The thickness of the vertical alignment film is not particularly restricted, however, it is generally 0.01 μm to 1 μm. If the vertical alignment film is thinner than 0.01 μm, it may be difficult to homeotropically align the polymerizable liquid crystals. On the other hand, if the vertical alignment film is thicker than 1 μm, the vertical alignment film itself would diffuse light, thus possibly decreasing the light transmittance ratio of the optical elements significantly.

The resin composition to be applied to the vertical alignment film may be prepared by dissolving one type, or more than two types of compounds (I) or compounds (II), etc., given as examples above, a polymerization initiator, and when necessary a polymerization inhibitor etc., in an organic solvent. Furthermore, the component to be adopted to compose the vertical alignment film, that is, a surfactant, a silane coupling agent, or another vertical alignment (VA) film component may be further added to the resin composition. By adding a vertical alignment film component to the resin composition, the affinity between the vertical alignment film and the resin composition is enhanced, thus preferable because a more stable vertical alignment becomes possible. The thickness of the resin composition after drying is not particularly restricted, however, it is generally 0.1 μm to 5 μm. If the thickness is less than 0.1 μm, sufficient retardation may not be demonstrated. Furthermore, if it is 0.5 μm or above, the liquid crystal molecules surrounding the air side interface may not be capable of maintaining the vertical alignment.

To create a positive A plate for the retardation control layer in the present invention, the crosslinkable liquid crystalline monomer must be nematically aligned in a direction horizontal to the substrate surface. In order to be concrete, first, a horizontal alignment film is formed on the top side of a coloring layer 11 to promote alignment in the horizontal direction, and a resin composition containing a crosslinkable, liquid crystalline monomer is applied on the top side of the horizontal alignment film, then heated to promote the horizontal alignment of the liquid crystalline monomer, and next, the aligned liquid crystalline monomer is photopolymerized by an irradiation of active radiation, such as ultraviolet radiation, etc. As a result, liquid crystalline polymer fixed in the alignment is formed, enabling the formation of a retardation control layer composed of the liquid crystalline polymer.

The horizontal alignment film is formed by applying a solution in which a resin, such as a polyamide resin or a polyimide resin, etc., has been dissolved over a coloring layer which is dried to form a coated film, and then performing a rubbing involving the application of friction in a given direction from the top side of the coated film, using a cloth-wrapped roller, etc. The thickness of the alignment film is not particularly restricted, however, it is generally 0.01 μm to 1 μm. If the thickness of the alignment film is less than 0.1 μm, sufficient alignment may not be demonstrated. Furthermore, if the thickness exceeds 1 μm, the alignment film itself will diffuse light, thus possibly decreasing the light transmittance ratio of the optical elements significantly.

The resin composition applied to the horizontal alignment film may be prepared by dissolving one type, or more than two types of compounds (I) or compounds (II), etc., given above as examples, a photopolymerization initiator, and when necessary a photopolymerization inhibitor, etc. in an organic solvent. The thickness of the resin composition in the positive A plate after drying is not particularly restricted, however, it is generally 0.1 μm to 5 μm. If the thickness is less than 0.1 μm, sufficient retardation may not be demonstrated. Furthermore, if the thickness exceeds 0.5 μm, the liquid crystal molecules surrounding the air side interface may not be capable of maintaining the alignment of the substrate interface.

A negative C plate in the present invention may be formed by directly applying a resin composition to which a further chiral agent has been added, as used to form the positive plate A, onto a coloring layer 11, followed by heating to promote the alignment of the liquid crystalline monomer, and then photopolymerizing the liquid crystalline monomer aligned as a result of an irradiation of active radiation, such as ultraviolet radiation, etc. The addition of the chiral agent will induce a twist in the alignment of the liquid crystalline monomer, permitting regulation of alignment of the liquid crystalline monomer so as to have a spiral structure. Next, the spirally aligned (that is, a chiral nematic alignment) liquid crystalline monomer is cross linked, and as a result, a liquid crystalline polymer fixed in the alignment is formed, enabling the formation of a retardation control layer composed of the liquid crystalline polymer. Alternatively, before applying the resin composition containing the chiral agent onto the coloring layer 11, a horizontal alignment film may first be formed on the top side of the coloring layer 11. As described, by forming a horizontal alignment film and applying a resin composition containing a chiral agent over the top side thereof, the spiral alignment is naturally initiated, and thus preferable as an alignment as less turbulence may be induced. The thickness of the resin composition in a negative C plate after drying is not particularly restricted, however, it is generally 0.1 μm to 5 μm. If the thickness exceeds 0.1 μm, sufficient retardation may not be demonstrated. Furthermore, if the thickness exceeds 5 μm, the liquid crystal molecules surrounding the air side interface may not be capable of maintaining the alignment of the substrate interface.

The chiral agent that may be used in the present invention is added for the purpose of inducing a spiral pitch with uniaxial nematic regularity, developed by compounds (I) given as examples in Chemical Formula 1 through Chemical Formula 10, or compounds (II) included in the general chemical formula cited in Chemical Formula 11. Therefore, it is important that the compound has optically active molecules. To be specific, compounds having one or more than two asymmetric carbons; compounds having an asymmetric point on the hetero atom such as chiral amine, or chiral sulfoxide, etc.; or compounds having an axial asymmetry such as cumulene, binaphthol and the like, may be cited. For example, commercially available chiral nematic liquid crystals, to be specific, S-811 or the like produced by Merck Co., may be used. Furthermore, the molecular weight of the chiral agent is preferably below 1500.

In the case of further laminating a different second retardation control layer on the top side of a first retardation control layer, as shown in FIG. 4, an alignment film is formed on the top side of first retardation control layer, then a resin composition containing a crosslinkable, liquid crystalline monomer is applied, aligned, and fixed so as to form the second retardation control layer. Or, in the case of a retardation control layer not requiring an alignment film, on the top side of the first laminated retardation control layer, a resin composition containing the liquid crystalline monomer is applied, aligned, and fixed so as to form the second retardation control layer.

As described above, with a conventional liquid crystal display, when the display is displayed for many hours in particularly high temperatures or high humidity, it becomes easy for impurities such as ionic substances, etc., to travel into the liquid crystal layer, and as a result, due to the impurities entering into the liquid crystal layer, a decrease in the voltage holding ratio becomes a problem.

However, with regard to the above-described retardation control layer in the present invention, any embodiment of which is composed by forming a liquid crystalline polymer in a fixed alignment using crosslinkable polymeriable liquid crystalline monomer, and cross linking by means of an irradiation of active radiation such as ultraviolet radiation, etc., after forming a desired alignment on the substrate. The retardation control layer, formed as described above, is capable of compensating for the phase difference of the liquid crystal layer in a liquid crystal display, and in addition, because the alignment of the liquid crystalline monomer is fixed, it becomes physically difficult for impurities such as ionic substances, etc., to pass through the structure.

Therefore, with the display base in the present invention having a retardation control layer, even after forced impurity extraction is conducted to forcefully extract impurities from a display base to a liquid crystal layer, with the retardation control layer in contact with the liquid crystal layer, the subsequent voltage is able to hold a value greater than 90% in the liquid crystal layer.

The colored layer 11 in the present invention may be formed by patterning the black matrix 18 (hereinafter referred to simply as “BM”) on the position equivalent to the non-colored element part consisting of light blocking material on the board 10, and optically-transparent colored elements on the position equivalent to each opening of the BM 18. Alternatively, it is possible to make patterns with only the colored elements and form a colored layer without the BM 18. The optically-transparent colored element includes a red-colored element 19R, a green-colored element 19G and a blue-colored element 19B, etc. Colored elements patterned and provided for each opening of the BM 18 are commonly formed using color elements with at least two colors. Also, when forming a colored layer without the BM 18, it is possible not to depend on the opening of the BM 18 and form each colored element with various patterns such as striped, mosaic, or triangle shapes.

The BM 18 in the present invention forms a resin layer where black pigments such as carbon particles are dispersed on the board 10, and using the photoresist method, each resin layer can be patterned as grating or stripes and formed as a lamination layer. Alternatively, the BM 18 can comprise a metal or a thin film of metal oxide. Metal or metal oxide may be a composite film with a two layer structure comprised of a single Cr layer and a CrOx/Cr (x indicates an arbitrary number, and “/” indicates a lamination layer) lamination layer, or a composite film with a three-layer structure comprised of lamination layers CrOₓ/CrN_{y}/Cr (x and y indicate arbitrary numbers). The BM 18 formed from metal or metal oxide as described above can be constructed by first forming the above-described thin film of metal or metal oxide using vapour deposition, ion plating, or a sputtering method, and then creating patterns using a photolithographic method. The materials and methods used to configure the BM 18 are examples, and any materials and methods may be selected arbitrarily from among commonly known materials and methods for forming a BM. The thickness of the BM 18 is not specifically restricted, however, it is generally 0.1 μm to 1.5 μm. If the thickness is less than 0.1 μm, it may cause light to be leaked from the BM. Also, if the thickness is above 1.5 μm, the smoothness of the color filter may degrade.

Patterns for each colored element can be formed using a photo-sensitive resin containing a desired colorant and employing a photolithographic method. Alternatively, it is possible to print and form patterns for the colored elements using an ink composition. The thickness of the colored element is not particularly restricted, however, it is generally 0.5 μm to 2 μm. The thickness of each colored element may be the same or different.

The board 10 in the present invention may be a board formed from transparent inorganic materials or transparent organic materials, in a sheet or film.

For the transparent inorganic materials, glass, silicon, or quartz are cited. Especially, quartz with a low heat expandability, great suitability of measurement, and excellent workability in high-temperature heating processes is preferable. Also, especially when using the color filter of the present invention for an LCD, it is preferable to use a non-alkali glass without an alkaline component for the board.

On the other hand, for the transparent organic materials, those comprised of an acryl, such as polymethylmethacrylate, polyamide, polyacetal, polybutylene terephthalate, polyethylene terephthalate, polyethylene naphthalate, triacetyl cellulose, or, syngiotactic polystyrene, etc., phenylene sulfide, polyether ketones, polyether ether ketone, fluorine resin, or, polyethernitrile, etc., polycarbonate, denaturated polyphenylene ether, polycyclohexane, or polynorbornen series resin, etc., or polysulphone, polyethersulphone, polyalylate, polyamide-imide, polyetherimide, or thermoplastic polyimide are cited. However, it is also possible to use those comprising common plastic. Especially for the film, a uniaxially stretched film or biaxially stretched film, or a TAC film that comprises retardation inside may be used. The thickness of the board 10 is not particularly restricted, however, it is commonly 0.05 mm to 1.5 mm depending on the application.

The following describes the method and conditions for forced impurity extraction.

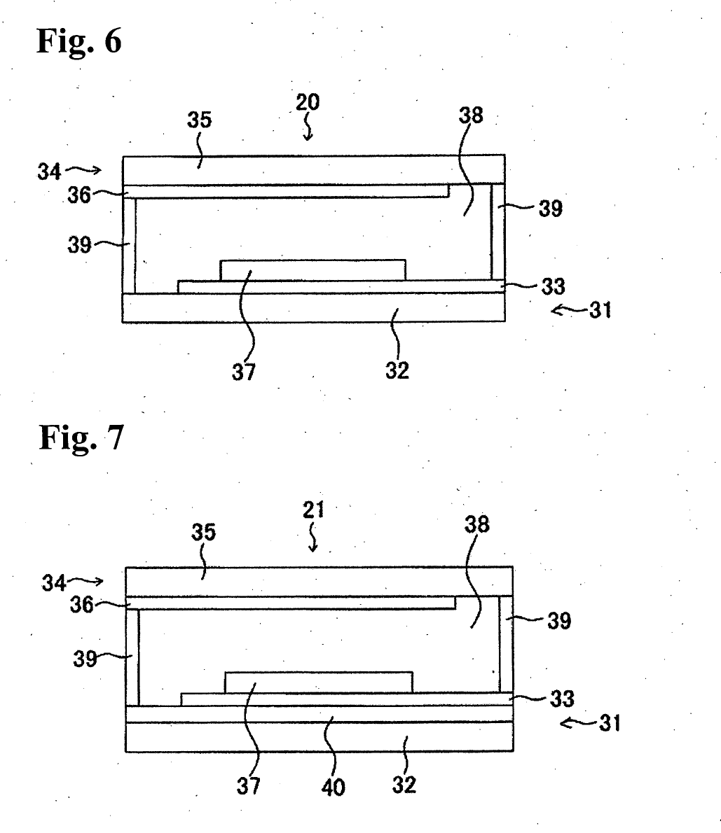

When performing a forced impurity extraction, first form the liquid crystal cell for measurement 20, as shown in FIG. 6. The liquid crystal cell for measurement 20 is formed by preparing a pair of ITO boards 31 and 34 with ITO (indium tin oxide) electrodes 33 and 36 on the surface of the glass boards 32 and 35, forming the retardation control layer 37 on the ITO electrode 33 of the other ITO board 31, then facing the other ITO board 34 so that the distance between the ITO electrodes is in the range of 5 μm to 15 μm, sealing the peripheral part with the seal member 39, and forming the LCD layer 38 comprised by encapsulating liquid crystal between both ITO boards. The retardation control layer 37 is formed under the same conditions as forming the display board of the present invention. When an alignment film is required, it may be first formed on the ITO boards 31 and 34. Also, the liquid crystal used in the liquid crystal layer 38 should have a 95% or higher voltage holding ratio, which is measured under the following conditions for measurement of voltage holding ratio using the liquid crystal cells for measurement 29 before processing for forced impurity extraction.

Alternatively, the liquid crystal cell for measurement 21 as shown in FIG. 7 may be created as another liquid crystal cell for measurement. The liquid crystal cell for measurement 21 may be comprised in the same way as the liquid crystal cell 20 for measurement except that a color filter 40 is provided between the glass board 32 and the ITO electrode 33. The color filter 40 may be formed in the same way as the colored layer 11.

Next, the process for forced impurity extraction may be performed for the retardation control layer 37 by placing the liquid crystal cell for measurement 20 or 21 in an oven and heat processing at 105° C. for 2.5 hours.

The following describes the voltage holding ratio.

Allow the liquid crystal cell for measurement 20 or 21, which is processed for forced impurity extraction as described above, to return to room temperature, apply a voltage according to the following conditions and measure the retention rate.
Distance between ITO electrodes: 5 to 15 μm
Voltage pulse amplitude: 5 V
Voltage pulse frequency: 60 Hz
Voltage pulse width: 16.67 msec
To measure the voltage holding ratio, a commercially available device such as VHR-1A type/1S type (TOYO Corporation) may be used.

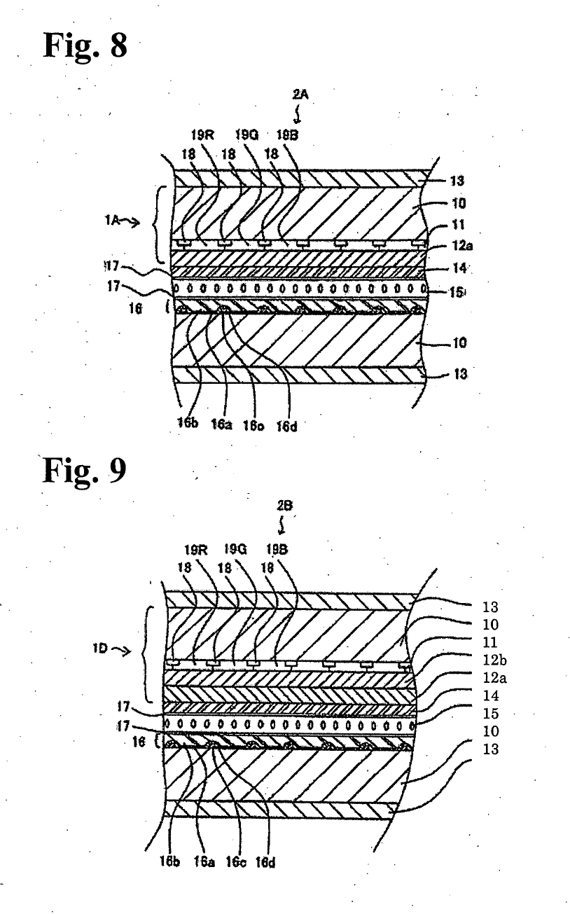

FIG. 8 is a cross-sectional view showing one embodiment of the LCD 2A of the present invention. In the LCD 2A, the upper side is the observation side. On the observation side, the polarizing plate 13, the board 10, the colored layer 11 comprising the BM 18 and colored elements 19R, 19G, and 19B, the retardation control layer 12a, the opposed electrode layer 14, the alignment film 17, the liquid crystal layer 15, the alignment film 17, the element electrode layer 16, the board 10, and the polarizing plate 13 are provided. The element electrode layer 16 is comprised of the element electrode 16a to which patterns are given opposing each colored element located above, the operating line 16c, the insulation layer 16d that isolates the element electrode 16a and the operating line 16c, and the protection layer 16d located between these and the alignment film 17. The display board 1A comprising the board 10, the colored layer 11 and the retardation control layer 12a is the display board 1A of the present invention and comprises the retardation control layer 12a that forms the positive C plate.

The LCD 2B shown in FIG. 9 may be formed in the same way as the LCD 2A shown in FIG. 8, except the LCD 2B uses the display board 1D, comprising the board 10, the colored layer 11, and the retardation control layer 12b followed by the retardation control layer 12a. The display board 1D comprising board 10, the colored layer 11, the retardation control layer 12b, and the retardation control layer 12a is the display board 1D of the present invention comprising the retardation control layer 12a that forms the positive C plate and the retardation control layer 12b that follows the retardation control layer 12a, and forms the positive A plate.

In addition, the LCDs shown in FIGS. 8 and 9 are not intended to limit the LCD of the present invention. The LCD of the present invention is an LCD formed using the display board of the present invention with the liquid crystal and the retardation control layer making contact with each other, or when they are placed in as close proximity as possible to each other.

Especially in terms of the LCD of the present invention, it is important that the liquid crystal and the retardation control layer make contact with each other or are placed as close together as possible. Because the retardation control layer of the present invention comprises a cross-linked liquid crystalline polymer, impurities such as ionic substances are physically prevented from passing through the retardation control layer. Therefore, by placing the retardation control layer as close as possible to the liquid crystal layer, the impurities are prevented from entering the liquid crystal layer from the composition layer located opposite the liquid crystal layer via the retardation control layer. In the present invention, the location “as close as possible” to the liquid crystal layer does not intend to imply the removal of all other layers between the retardation control layer and the liquid crystal layer, and a layer required in the display structure, for example, the alignment film or electrode layer for the liquid crystal layer, may be present.

Also, for a conventionally used retardation film, an adhesive is used to attach the film to the polarizing plate. However, the process of attaching the film or the adhesive is considered to be the source of impurities. In the present invention, the retardation control layer can be formed without using adhesive. Therefore, the conventional retardation film is not required, and the adhesive used to attach a film and the attaching process are not required. These differences are important points in the realization of the present invention.

Because the LCD of the present invention is manufactured using the present invention's display board, which is able to retain a high voltage on the contacted liquid crystal layer even when the voltage is applied after forced impurity extraction, a flicker does not occur and a high-quality display can be maintained even for display over many hours (for example, continuous display of an image for 200 hours at 50° C., 60% RH)

### EXAMPLES

The following describes the present invention in more detail by reference to exemplary embodiments and comparative examples.

Board Pre-Processing

An appropriate cleaning process is conducted and a non-alkali glass board with low-expansibility (7059 glass manufactured by Uning Inc., 100 mm×100 mm, thickness 0.7 mm) is prepared for the glass board. Then, ITO electrodes are formed on the surface of the glass board, and cleaned according to the determined method, thereby completing the glass board.

Blended Polymerization Nematic Liquid Crystal Solution

The polymerization nematic liquid crystal solution used to form the retardation control layer is blended as described below. A nematic liquid crystal solution is blended by mixing a compound (20 parts) shown in Formula 9 as a three-dimensional, cross-linkable liquid crystalline monomer with a nematic liquid crystal layer, Irg907 (0.8 parts) as a photo polymerization initiator, chlorobenzene (59.2 parts), and a vertical alignment film forming resolution JALS-2021-R2 with a resolution (20 parts) diluted to 12.5% using ethylene glycol methyl ether.

Blending Colored Resist

For the coloring materials in the black matrix, and the colored elements of red (R), (G), and (B), a pigment dispersive photoresist is used. The pigment dispersive photoresist uses pigments as coloring materials and is made by mixing a claresist composition (that includes polymer, monomer, additives, initiator, and solution) with a dispersion liquid from which beads added to the dispersion liquid composition (that includes pigment, dispersant, and solution) are removed, and then dispersing the liquid using a dispersing device for three hours. The compositions are listed below. In addition, a paint shaker is used as a dispersing device.

The composition of each photoresist is listed below.

(Photoresist for Black Matrix)

Black pigment . . . 14.0 parts

(TM Black #9550 Manufactured by Dainichiseika Color & Chemicals Mfg.Co.,Ltd.)

Dispersant . . . 1.2 parts

(Disper Big 111 Manufactured by BYK Chemie Japan K.K)

Polymer . . . 2.8 parts

(VR60 Manufactured by SHOWA HIGHPOLYMER CO., LTD.)

Monomer . . . 3.5 parts

(SR399 Manufactured by Sartomer Company)

Additives . . . 0.7 parts

(L-20 Manufactured by Soken Chemical & Engineering Co., Ltd.)

Initiator . . . 1.6 parts

(2-benzyl-2-dimethylamino-1-(4-morpholinophenyl-)-butanon e-1)

Initiator . . . 0.3 parts

(4,4′-dimethylaminobenzophenone)

Initiator . . . 0.1 parts

(2,4-diethylaminobenzophenone)

Solution . . . 75.8 parts

(Ethylene Glycol Monobutyl Ether)

(Red (R) Photoresist for Colored Element)

Red pigment . . . 4.8 parts

(C. I. PR254 (Chromophthal DPP Red BP Manufactured by Ciba Specialty Chemicals)

Yellow pigment . . . 1.2 parts

(Paliotol Yellow D1819 Manufactured by BASF)

Dispersant . . . 3.0 parts

(Sol Sperse 24000 Manufactured by Zeneca)

Monomer . . . 4.0 parts

(SR399 Manufactured by Sartomer Company)

Polymer 1 . . . 50 parts

Initiator . . . 1.4 parts

(Irgacure 907 Manufactured by Ciba Specialty Chemicals)

Initiator . . . 0.6 parts

(2,2′-bis(o-chlorophenyl)-4,5,4′,5′-tetraphenyl-1, 2′-biimidazole)

Solution . . . 80.0 parts

(Propylene Glycol Monomethyl Ether Acetate)

(Green (G) Photoresist for Colored Element)

Green pigment . . . 3.7 parts

(C. I. PG7 (Seika Fast Green 5316P Manufactured by Dainichiseika Color & Chemicals Mfg. Co., Ltd.)

Yellow pigment . . . 2.3 parts

(C. I. PY139 (Paliotol Yellow D1819 Manufactured by BASF)

Dispersant . . . 3.0 parts

(Sol Sperse 24000 Manufactured by Zeneca)

Monomer . . . 4.0 parts

(SR399 Manufactured by Sartomer Company)

Polymer 1 . . . 5.0 parts

Initiator . . . 1.4 parts

(Irgacure 907 Manufactured by Ciba Specialty Chemicals)

Initiator . . . 0.6 parts

(2,2′-bis (o-chlorophenyl)-4,5,4′,5′-tetraphenyl-1, 2′-biimidazole)

Solution . . . 80.0 parts

(Propylene Glycol Monomethyl Ether Acetate)

(Blue (B) Photoresist for Colored Element)

Blue pigment . . . 4.6 parts

(C. I. PB15:6 (Heliogen Blue L6700F Manufactured by BASF))

Violet pigment . . . 1.4 parts

(C. I. PV23 (Foster Palm RL-NF Manufactured by Clariant))

Pigment derivative . . . 0.6 parts

(Sol Sperse 12000 Manufactured by Zeneca)

Dispersant . . . 2.4 parts

(Sol Sperse 24000 Manufactured by Zeneca)

Monomer . . . 4.0 parts

(SR399 Manufactured by Sartomer Company)

Polymer 1 . . . 5.0 parts

Initiator . . . 1.4 parts

(Irgacure 907 Manufactured by Ciba Specialty Chemicals)

Initiator . . . 0.6 parts

(2,2′-bis (o-chlorophenyl)-4,5,4′,5′-tetraphenyl-1, 2′-biimidazole)

Solution . . . 80.0 parts

(Propylene Glycol Monomethyl Ether Acetate)

In addition, for the polymer 1 described in the present specification, 2-methacryloyloxy ethyl isocyanate is added by 16.9 mol % relative to copolymer 100 mol % of benzyl methacrylate styrene:acrylic acid: 2-hydroxyethylmethacrylate=15.6:37.0: 30.5:16.9 (molar ratio) and the average molecular weight is 42500.

### Example 1

Using a solution created by diluting JALS-2021-R2 to 50% using γ-butyrolactone as the vertical alignment film solution, patterns are made on the surfaces of an ITO electrode on the glass board using a flexographic printing method, and a film is formed with a thickness of 600 Å. Then, the film is baked at 180° C. for one hour and a vertical alignment film is formed on the board. Next, the board on which the vertical alignment film is formed is set on a spin coater, and the previously blended polymerization nematic liquid crystal solution is spin coated onto the vertical alignment film so that the thickness of the film after drying is approximately 1.5 μm. Note that in the present example embodiment, a spin coating method is employed as the method for applying the liquid crystal solution; however, the method for applying the liquid crystal solution is not limited to a spin coating method. For example, a die coating method, slit coating method or a combination of these methods can be selected accordingly. This also applies to the example embodiments described below. Next, the board to which the liquid crystal solution was applied is heated on a hot plate to 100° C. for three minutes to remove the remaining solution. Also, the liquid crystalline polymer contained in the liquid crystal solution is processed so as to be vertically oriented. According to a visual inspection of the liquid crystal transition point, where the film formed by the liquid crystal solution turns from white to transparent, the orientation of the liquid crystal molecules is confirmed. After being subjected to the orientation processing, ultraviolet light is emitted to the liquid crystal layer by an ultraviolet light emitting device with a ultrahigh pressure mercury lamp at 20 mW/cm² for 10 seconds in air atmosphere, and the polymerizable liquid crystals that consist of the liquid crystal layers are polymerized and the three-dimensional cross-linked retardation control layer is formed on the glass board.

Then, by facing the glass board on which the retardation control layer is formed to the glass board on which the ITO electrodes are formed, a liquid crystal cell for measurement is formed. The distance between the facing boards is set so that the distance between the ITO electrodes is in the range of 5 to 15 μm and the distance between the both boards are sealed by sealing member. Then, the liquid crystal cell for measurement 1 is formed by injecting liquid crystal (MLC-6846-000 manufactured by Merck Ltd. , Japan) into the space formed by the distance between both boards and the sealing member, and sealing the inlet.

In the liquid crystal cell for measurement of the example of embodiment 1, before the forced impurity extraction, a voltage was applied and the voltage holding ratio of the liquid crystal layer was measured. The voltage holding ratio of the liquid crystal layer was 98.6%.

### Example 2

An appropriate cleaning process is conducted and a non-alkali glass board with a low-expansibility (7059 glass manufactured by Uning Inc., 100 mm×100 mm, thickness 0.7 mm) is prepared as the glass board. Then, a colored layer is formed on the surface of the glass board and ITO electrodes are formed on the surface of the colored layer. Then, on the surface of the ITO electrode, a retardation control layer is formed as in the example embodiment 1, and the liquid crystal cell for measurement 2 is formed. In addition, the colored layer on the surface of the glass board is formed as described below.

On the surface of the cleaned glass board, the photoresist for the BM blended as described above is applied with a thickness of 1.2 μm using a spin coating method, and pre-baked at 80° C. and for three minutes. Then, it is exposed (100 mJ/cm²) using a mask formed in predetermined patterns and after being subjected to spray development using 0.05% KOH solution for 50 seconds, the photoresist for the BM is post-baked at 230° C. for 30 minutes, completing the BM board.

Then, red (R) pigment dispersive photresist is applied on the BM board using a spin coating method, pre-baked at 90° C. for three minutes, and subjected to alignment exposure (100 mJ/cm²) using a photomask for a predetermined colored pattern. Then, after being subjected to spray development using 0.1% KOH solution for 50 seconds, the photoresist is post-baked at 230° C. for 30 minutes, and red (R) colored element patterns with a thickness of 1.2 Am are formed at a predetermined position relative to the BM patterns.

Then, green (G) colored element patters with a thickness of 1.2 μm are formed using the same method and under the same conditions as the red (R) colored element patterns.

In addition, blue (B) colored element patters with a thickness of 1.2 μm are formed using the same method and under the same conditions as the red (R) colored element patterns.

As described above, a colored layer consisting of a BM, red colored element, green colored element, and blue colored element is formed on the board.

### Comparative Example 1

Other than the fact that a retardation control layer is not formed, the liquid crystal cell for measurement 3 in the comparative example 1 is formed as in example 2.

In the liquid crystal cell for measurement of the comparative example 1, before the forced impurity extraction, a voltage was applied and the voltage holding ratio of the liquid crystal layer was measured. The voltage holding ratio of the liquid crystal layer was 95.8%.

### Example 3

An appropriate cleaning process is conducted and a non-alkali glass board with a low-expansibility (7059 glass manufactured by Uning Inc., 100 mm×100 mm, thickness 0.7 mm) is prepared for the board. Then, for the blending of the colored resist, using black matrix, and coloring materials of red (R), green (G), blue (B) colored elements, a colored layer is formed in the same way as the method for forming a colored layer in example embodiment 2. Using the same method as that for forming a retardation control layer in example of embodiment 1, on the surface of the colored layer, a retardation control layer is formed from vertically oriented three-dimensional cross-linked liquid crystals. Then, on the surface of the retardation control layer, a transparent common electrode made of indium tin oxide (ITO) is formed. On the other hand, on the glass board prepared as described above, a thin film transistor (TFT) is formed at predetermined multiple locations, and an opposing electrode board is formed by forming a transparent element electrode using indium tin oxide (ITO) so that the electrode connects to the drain electrode of each TFT.

Then, an alignment film (thickness of 0.07 μm) is provided by applying a polyimide resin coating to cover the transparent common electrode side and transparent element electrode side and upon drying the coating, the electrodes are oriented. Then, the LCD device 1 is constructed by facing both boards so that these alignment films face each other, sealing the distance between both of the boards with a sealing member, injecting liquid crystal (MLC-6846-000 manufactured by Merck Ltd., Japan) into the sealed space, and sealing the inlet.

### Comparative Example 2

Other than the fact that a retardation control layer is not formed, the LCD device 2 is constructed in the same was as in example 3.

Evaluation 1

The liquid crystal cells for measurements 1 to 3 in the examples 1 and 2, and comparative example 1, are each placed into an oven and the forced impurity extraction is performed at 105° C. for 2.5 hours. Then, after removing each liquid crystal cell for measurement from the oven and allowing it to return to room temperature, a voltage is applied and the voltage holding ratio is measured under the conditions. Table 1 lists the measurement results.

TABLE 1

| | Voltage holding | Voltage holding |
|---|---|---|
| | ratio before forced | ratio after forced |
| | impurity extraction | impurity extraction |
| | (%) | (%) |
| Liquid crystal cell | 98.6 | 95.8 |
| for measurement 1 | | |
| Liquid crystal cell | 97.2 | 95.7 |
| for measurement 2 | | |
| Liquid crystal cell | 95.8 | 76.4 |
| for measurement 3 | | |

Evaluation 2

The LCD device 1 constructed in example 3 above and the LCD device 2 in comparative example 2 are turned on for an extended period of time under the following two types of high temperature and high humidity conditions. The display quality is then evaluated according to the following standards and the results are listed in Table 2.

Image Display Conditions

Display conditions 1: Continuous display for 200 hours at 50° C. and 60%

Display conditions 2: Continuous display for 500 hours at 80° C. and 60%

Evaluation Standards for Display Quality

◯: The display quality is excellent without flickering on the display

×: The occurrence of display defects are recognized by flickering on the display

TABLE 2

Display quality

| | Display conditions | Display conditions |
|---|---|---|
| | 1 | 2 |
| LCD device 1 | ◯ | ◯ |
| LCD device 2 | X | X |

Before the forced impurity extraction, the liquid crystal cells 1 to 3 showed a high voltage holding ratio with 90% or higher, as listed in Table 1. After performing the forced impurity extraction, the liquid crystal cells 1 and 2 comprising the retardation control layer held a voltage with a value of 90% or higher. On the other hand, for the liquid crystal cell not comprising a retardation control layer, the voltage holding ratio was significantly lowered to 90% or below due to the process for forced impurity extraction.

Also, as listed in Table 2, the LCD device 1 comprising a display board with the retardation control function showed a high quality display without any flickering under both display conditions. On the other hand, the LCD device 2 not comprising a display board with the retardation control function showed flickering under both display conditions, and display defects were recognized.

The disclosure of Japanese Patent Application No. 2005-105514 filed on Mar. 31, 2005, is incorporated herein.

What is claimed is:

1. A display board having a retardation control function, the display board comprising:
a retardation control layer comprising liquid crystalline polymers with a fixed orientation;
a substrate, the display board having a voltage holding ratio of 90% or higher after a forced impurity extraction is performed on the display board with the retardation control layer in contact with the liquid crystal layer, and application of a voltage to the liquid crystal layer.

2. A display board according to claim 1, further comprising
a substrate; and
a colored layer disposed between the substrate and the retardation control layer.

3. A liquid crystal display comprising the display board having a retardation control function according to claim 1.

4. A liquid crystal display according to claim 3, further comprising
a common electrode,
a first alignment film,
a liquid crystal layer,
a second alignment film, and
a pixel electrode,
the retardation control layer being disposed on a surface opposite the first alignment film of the common electrode.
